(19) United States
(12) Patent Application Publication
(10) Pub. No.: US 2021/0342970 A1
(43) Pub. Date: Nov. 4, 2021

(54) METHOD AND DEVICE FOR PROCESSING IMAGE, AND STORAGE MEDIUM

(71) Applicant: BEIJING SENSETIME TECHNOLOGY DEVELOPMENT CO., LTD., Beijing (CN)

(72) Inventors: Tong LI, Beijing (CN); Wentao Liu, Beijing (CN); Chen Qian, Beijing (CN)

(21) Appl. No.: 17/377,444

(22) Filed: Jul. 16, 2021

Related U.S. Application Data
(63) Continuation of application No. PCT/CN2020/093442, filed on May 29, 2020.

(30) Foreign Application Priority Data
Dec. 25, 2019 (CN) 201911360894.4

(51) Int. Cl. G06T 3/00; G06K 9/32; G06T 7/70

(52) U.S. Cl. CPC G06T 3/0012; G06T 2207/30196; G06T 7/70; G06K 9/3233

(57) ABSTRACT

Location information of a first key point of a first part contained in a target object in a first image is acquired. A first region containing the first key point is determined based on the location information of the first key point. A displacement of a mesh point of a preset morphing mesh in the first region is determined according to a location of the mesh point in the first region with respect to a pixel point in the first region. A morphed second image is acquired by morphing the pixel point in the first region according to the displacement of the mesh point in the first region.

### CROSS-REFERENCE TO RELATED APPLICATIONS

This application is a continuation of International Application No. PCT/CN2020/093442, filed on May 29, 2020, which per se is based on and claims benefit of priority to Chinese Application No. 201911360894.4, filed on Dec. 25, 2019. The disclosures of International Application No. PCT/CN2020/093442 and Chinese Application No. 201911360894.4 are hereby incorporated by reference in their entireties.

### TECHNICAL FIELD

The subject disclosure relates to the field of images, and more particularly, to a method and device for processing an image, and a storage medium.

### BACKGROUND

In field of image technology, a portion of a photo a user has taken may have to be morphed. Currently, it is common to morph an entire image or to morph some regions of the image without morphing other regions. When just some regions of an image are morphed, transition between a morphed region and a non-morphed region may be unnatural, rendering an image effect poor, decreasing a user experience.

### SUMMARY

Embodiments herein provide a method and device for processing an image, and a storage medium.

A technical solution herein may be implemented as follows.

According to a first aspect herein, a method for processing an image includes:

acquiring location information of a first key point of a first part contained in a target object in a first image;

determining a first region containing the first key point based on the location information of the first key point;

determining, according to a location of a mesh point of a preset morphing mesh in the first region with respect to a pixel point in the first region, a displacement of the mesh point in the first region; and

acquiring a morphed second image by morphing the pixel point in the first region according to the displacement of the mesh point in the first region.

In some optional embodiments herein, determining, according to the location of the mesh point of the preset morphing mesh in the first region with respect to the pixel point in the first region, the displacement of the mesh point in the first region may include:

determining an attenuation parameter of the displacement of the mesh point according to the location of the mesh point of the preset morphing mesh in the first region with respect to the pixel point in the first region, and determining a first displacement of the mesh point according to a morphing instruction; and

acquiring a second displacement less than the first displacement by attenuating the first displacement according to the attenuation parameter.

In some optional embodiments herein, acquiring the morphed second image by morphing the pixel point in the first region according to the displacement of the mesh point in the first region may include:

acquiring the morphed second image by controlling a spacing between adjacent pixel points in the first region according to the second displacement.

In some optional embodiments herein, determining the attenuation parameter of the displacement of the mesh point according to the location of the mesh point of the preset morphing mesh in the first region with respect to the pixel point in the first region may include:

acquiring a first set by determining pixel points located on a line connecting a plurality of the first key point;

acquiring a second set according to the location of the mesh point of the preset morphing mesh with respect to a pixel point in the first set, the second set including target mesh points of the morphing mesh each being closest to a pixel point in the first set; and

determining the attenuation parameter of a target mesh point in the second set according to a location of the target mesh point in the second set with respect to a pixel point in the first set controlled by the target mesh point in the second set.

In some optional embodiments herein, determining the attenuation parameter of the target mesh point in the second set according to the location of the target mesh point in the second set with respect to the pixel point in the first set controlled by the target mesh point in the second set may include:

acquiring a rank of spacing between the target mesh point in the second set and each of the first key point along a predetermined direction by traversing the target mesh point in the second set outward along the predetermined direction starting from a center taken as the each of the first key point; and

determining the attenuation parameter of the target mesh point in the second set according to the rank of spacing.

In some optional embodiments herein, determining the attenuation parameter of the target mesh point in the second set according to the rank of spacing may include:

in response to any one of the target mesh points in the second set being located along the predetermined direction with respect to the plurality of the first key point, determining alternative attenuation parameters according to the rank of spacing corresponding to the plurality of the first key point; and

selecting a maximum alternative attenuation parameter of the alternative attenuation parameters as the attenuation parameter of the any one of the target mesh points.

In some optional embodiments herein, the first part may be an upper limb. Acquiring the location information of the first key point of the first part contained in the target object in the first image may include: acquiring location information of a skeleton key point of the upper limb in the first image. The skeleton key point may include at least one of a shoulder key point, an elbow key point, a wrist key point, and a hand key point.

In some optional embodiments herein, the method may further include:

determining, according to location information of a second key point of a second part contained in a target object in the first image, a second region corresponding to the second part; and

acquiring the morphed second image by morphing the second region in the first image according to a first displacement of a mesh point of a preset morphing mesh in the second region.

According to embodiments herein, a device for processing an image includes an acquiring module, a first determining module, a second determining module, and a controlling module.

The acquiring module is configured for acquiring location information of a first key point of a first part contained in a target object in a first image.

The first determining module is configured for determining a first region containing the first key point based on the location information of the first key point.

The second determining module is configured for determining, according to a location of a mesh point of a preset morphing mesh in the first region with respect to a pixel point in the first region, a displacement of the mesh point in the first region.

The controlling module is configured for acquiring a morphed second image by morphing the pixel point in the first region according to the displacement of the mesh point in the first region.

In some optional embodiments herein, the second determining module may be configured for:

determining an attenuation parameter of the displacement of the mesh point according to the location of the mesh point of the preset morphing mesh in the first region with respect to the pixel point in the first region, and determining a first displacement of the mesh point according to a morphing instruction; and

acquiring a second displacement less than the first displacement by attenuating the first displacement according to the attenuation parameter.

In some optional embodiments herein, the controlling module may be configured for acquiring the morphed second image by controlling a spacing between adjacent pixel points in the first region according to the second displacement.

In some optional embodiments herein, the second determining module may be configured for:

acquiring a first set by determining pixel points located on a line connecting a plurality of the first key point;

acquiring a second set according to the location of the mesh point of the preset morphing mesh with respect to a pixel point in the first set, the second set including target mesh points of the morphing mesh each being closest to a pixel point in the first set; and

determining the attenuation parameter of a target mesh point in the second set according to a location of the target mesh point in the second set with respect to a pixel point in the first set controlled by the target mesh point in the second set.

In some optional embodiments herein, the second determining module may be configured for:

acquiring a rank of spacing between the target mesh point in the second set and each of the first key point along a predetermined direction by traversing the target mesh point in the second set outward along the predetermined direction starting from a center taken as the each of the first key point; and

determining the attenuation parameter of the target mesh point in the second set according to the rank of spacing.

In some optional embodiments herein, the second determining module may be configured for:

in response to any one of the target mesh points in the second set being located along the predetermined direction with respect to the plurality of the first key point, determining alternative attenuation parameters according to the rank of spacing corresponding to the plurality of the first key point; and

selecting a maximum alternative attenuation parameter of the alternative attenuation parameters as the attenuation parameter of the any one of the target mesh points.

In some optional embodiments herein, the first part may be an upper limb.

The acquiring module may be configured for acquiring location information of a skeleton key point of the upper limb in the first image. The skeleton key point may include at least one of a shoulder key point, an elbow key point, a wrist key point, and a hand key point.

In some optional embodiments herein, the first determining module may be further configured for determining, according to location information of a second key point of a second part contained in a target object in the first image, a second region corresponding to the second part.

The controlling module may be further configured for acquiring the morphed second image by morphing the second region in the first image according to a first displacement of a mesh point of a preset morphing mesh in the second region.

According to a third aspect herein, a device for processing an image may include memory and a processor connected to the memory. The processor is configured for implementing a method for processing an image according to any technical solution herein by executing computer-executable instructions stored on the memory.

According to a fourth aspect herein, a computer storage medium has stored thereon computer-executable instructions which, when executed by a processor, implement a method for processing an image according to any technical solution herein.

With a technical solution herein, before the entire first image is morphed using the morphing mesh, the first key point of the first part may be determined first. Then, pixel points in the first region to be protected may be acquired based on the first key point. In morphing, in the first region, a displacement of a mesh point may be determined based on a location of the mesh point with respect to a pixel point, instead of based on only a single morphing instruction. The displacement of a mesh point is determined by introducing the location of the mesh point with respect to a pixel point. In this way, pixel morphing in different regions of the same image may be controlled precisely by precise control of the displacement of a mesh point in the first region, thereby enhancing the effect in image morphing.

### BRIEF DESCRIPTION OF THE ACCOMPANYING DRAWINGS

FIG. 1 is a flowchart of a method for processing an image according to an embodiment herein.

FIG. 2A is a diagram of using a standard morphing mesh laid on a first image according to an embodiment herein.

FIG. 2B is a diagram of a first region and a second region according to an embodiment herein.

FIG. 3 is a flowchart of determining an attenuation parameter according to an embodiment herein.

FIG. 4 is a diagram of a line connecting key points and mesh points of a second set according to an embodiment herein.

FIG. 5 is a diagram of a structure of a device for processing an image according to an embodiment herein.

FIG. 6 is a diagram of a structure of a device for processing an image according to an embodiment herein.

### DETAILED DESCRIPTION

A technical solution herein will be further elaborated below in conjunction with the drawings and specific embodiments of the specification.

A term used in an embodiment herein is merely for describing the embodiment instead of limiting the subject disclosure. A singular form “a” and “the” used in an embodiment herein and the appended claims may also be intended to include a plural form, unless clearly indicated otherwise by context. Further note that a term “and/or” used herein may refer to and contain any combination or all possible combinations of one or more associated listed items.

Note that although a term such as first, second, third may be adopted in an embodiment herein to describe various kinds of information, such information should not be limited to such a term. Such a term is merely for distinguishing information of the same type. For example, without departing from the scope of the embodiments herein, the first information may also be referred to as the second information. Similarly, the second information may also be referred to as the first information. Depending on the context, a term “if” as used herein may be interpreted as “when” or “while” or “in response to determining that”.

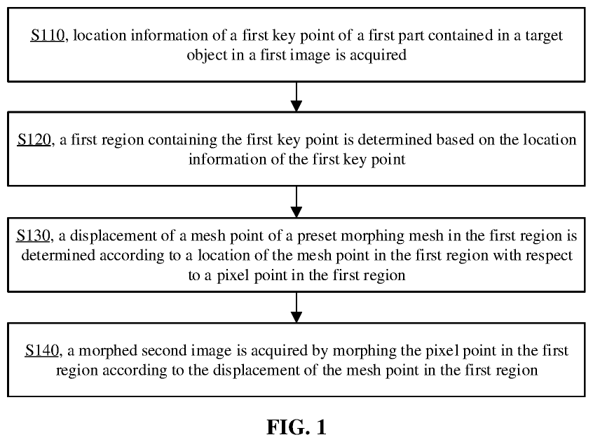

As shown in FIG. 1, embodiments herein provide a method for processing an image. The method may include steps as follows.

In S110, location information of a first key point of a first part contained in a target object in a first image is acquired.

In S120, a first region containing the first key point is determined based on the location information of the first key point.

In S130, a displacement of a mesh point of a preset morphing mesh in the first region is determined according to a location of the mesh point in the first region with respect to a pixel point in the first region.

In S140, a morphed second image is acquired by morphing the pixel point in the first region according to the displacement of the mesh point in the first region.

A method for processing an image herein may be applied to electronic equipment with an image processing function. Exemplarily, the image device may include various kinds of terminal equipment. The terminal equipment may include a mobile phone, wearable equipment, etc. The terminal equipment may also include on-board terminal equipment, fixed terminal equipment dedicated to image collection and fixed in a certain place, etc. In other embodiments, the image device may further include a server such as a local server, a cloud server located in a cloud platform providing an image processing service, etc.

In some embodiments, a target object may be a human, an animal, a virtual object formed by rendering a virtual three-dimensional model, etc., for example. A specific form of a target object is not limited hereto. A first part of a target object may be a limb. For example, when the target object is a human, the first part of the target object may be an arm, a leg, an abdomen, etc., which is not limited hereto.

In the embodiment, before performing image morphing, the first image may be divided into multiple regions. The first region may include one or more of the multiple regions.

In some embodiments, the first region may be a region containing the first part where morphing is to be suppressed. Alternatively, the first region may be a region containing the first part where morphing is to be enhanced. Exemplarily, a region containing the first part where morphing is to be enhanced may be a region where large morphing is required. A region containing the first part where morphing is to be suppressed may be a region where small morphing is required

In the embodiment, after a first image has been acquired, a morphing mesh may be determined before morphing the first image. For example, a morphing mesh may be laid on the first image. Exemplarily, a morphing mesh may include mesh points formed by widthwise lines and lengthwise lines intersecting each other. A widthwise line contained in a morphing mesh may be referred to as a latitude line. A lengthwise line contained in a morphing mesh may be referred to as a longitude line. Lines in a morphing mesh may be collectively referred to as longitude and latitude lines. Before the first image is morphed, the longitude and latitude lines may be standard straight lines laid respectively in a widthwise direction and a lengthwise direction.

If the morphing mesh composed of the longitude and latitude lines is morphed uniformly, regions in the image are morphed with identical morphing amplitudes. Consequently, a region not to be morphed, a region requiring small morphing, or a region requiring large morphing will be morphed indiscriminately according to a uniform morphing amplitude. Morphing according to a uniform morphing amplitude may cause inconsistency in a generated second image, etc., thereby rendering a poor effect in morphing the first image.

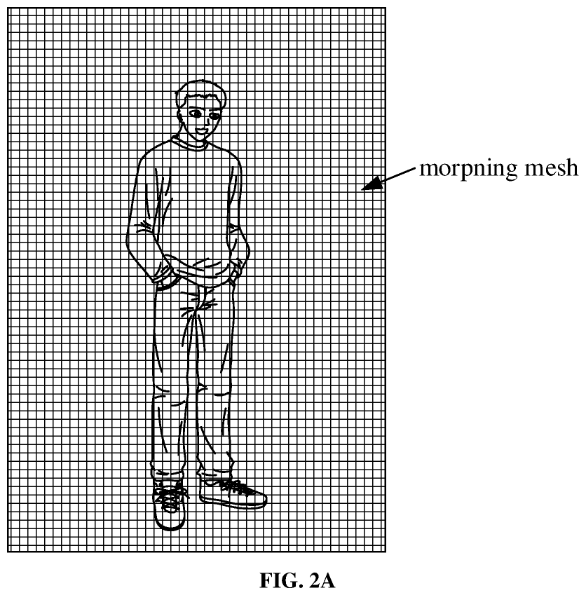

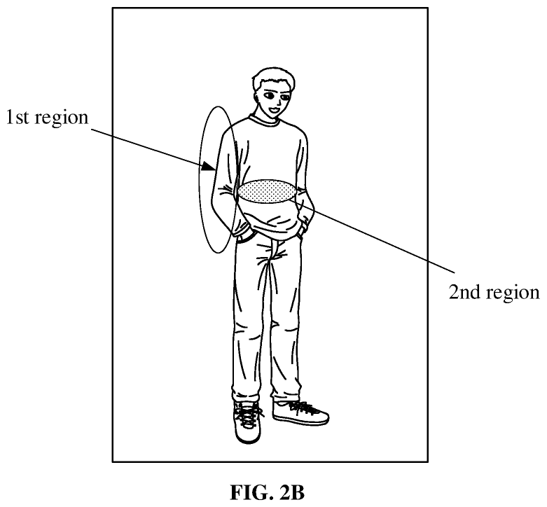

FIG. 2A is a diagram where a preset morphing mesh is laid. In FIG. 2B, taking the portrait in FIG. 2A as an example, a right upper limb region may be determined as the first region.

In the embodiment, a first key point of a first part contained in a target object in a first image may be determined first. Exemplarily, the first key point may be a skeleton key point or a contour key point of the first part. A skeleton key point may be a key point at a location of a human bone or an animal bone. A contour key point may be a key point of a contour presented on the surface of a human or an animal. Understandably, the first key point may be a point located on the first part, and may be used to locate a point of the first part. A location where skeleton key points are distributed may determine a location of the first part in the first image. Therefore, in the embodiment, the first region may be determined based on the location of one or more skeleton key points.

In the embodiment, in S120, at least a boundary of a first region may be determined based on the location information of the first key point. The first region may be determined based on the boundary of the first region. In S130, after the first region has been determined, pixel points in the first region may be acquired.

In the embodiment, image morphing using a preset morphing mesh may be referred to as mesh morphing. In some embodiments, in morphing an image using a preset morphing mesh, a pixel point in the first region may have to be moved. After a pixel point has been moved, a spacing between pixel points may change.

In some embodiments, S140 may include a step as follows. Pixel points in the first region may be morphed by adjusting a density of the pixel points in the first region according to a displacement of a mesh point in the first region, acquiring a morphed second image.

In this way, the first key point of the first part in the first image may be determined. Then, pixel points in the first region may be acquired based on the first key point. In image morphing, in the first region, a displacement of a mesh point may be determined based on a location of the mesh point with respect to a pixel point, instead of based on only a single morphing instruction. In this way, pixel morphing (that is, spacing between pixel points) in different regions of the image may be controlled precisely by precise control of the displacement of a mesh point in the first region, thereby enhancing the effect in image morphing.

In some optional embodiments herein, S130 may include a step as follows. An attenuation parameter of the displacement of the mesh point may be determined according to the location of the mesh point of the preset morphing mesh in the first region with respect to the pixel point in the first region. A first displacement of the mesh point may be determined according to a morphing instruction. A second displacement less than the first displacement may be acquired by attenuating the first displacement according to the attenuation parameter.

In the embodiment, a distance between a specific pixel in the first region and each mesh point may be acquired according to the location of a mesh point with respect to a pixel point in the first region. Then, the attenuation parameter of the displacement of the mesh point may be determined according to the distance. For example, the specific pixel point may be a pixel point at the first key point. Alternatively, the specific pixel point may be a pixel point near the first key point. This is only an example of determining the attenuation parameter of the displacement of a mesh point in the first region based on the relative location. The specification is not limited hereto.

In the embodiment, a morphing instruction may be an instruction generated based on a user input received by a man-machine interaction interface, or a morphing instruction generated based on an image preprocessing function such as one-click retouching, one-click body contouring, etc. For example, if there is an automatic waist slimming function for a portrait in an image, a device for processing an image will generate a morphing instruction corresponding to the automatic waist slimming function. The morphing instruction may carry a morphing parameter. Exemplarily, the morphing parameter may include the first displacement.

A first displacement may be determined. Then, a known first displacement may be attenuated using a known attenuation parameter, thereby acquiring a second displacement less than the first displacement.

In some optional embodiments herein, an attenuation parameter may be a parameter for reducing the displacement of a mesh point in the first region. A morphing amplitude of a pixel point in the first region may be positively correlated with the displacement of a mesh point in the first region. That is, the greater the displacement of a mesh point, the greater the morphing amplitude of a pixel point in the first region. Correspondingly, the less the displacement of the mesh point, the less the morphing amplitude of the pixel point in the first region.

In some optional embodiments, an attenuation parameter may include but is not limited to at least one of an attenuation coefficient or an attenuation value.

An attenuation coefficient may also be referred to as an attenuation ratio. For example, an original first displacement of each mesh point in the first region may be computed according to a morphing instruction. A final second displacement of each mesh point in the first region may be acquired as a product of the first displacement and the attenuation coefficient,.

If an attenuation value is positive, a second displacement that is less than the original first displacement may be acquired by subtracting the attenuation value from the original first displacement.

In some optional embodiments herein, S140 may include a step as follows. The morphed second image may be acquired by controlling a spacing between adjacent pixel points in the first region according to the second displacement.

Exemplarily, the spacing between some adjacent pixel points in the first region may be increased according to the second displacement. Additionally or alternatively, the spacing between some adjacent pixel points in the first region may be decreased according to the second displacement. Therefore, the morphed first region may become characterized of unequal spacing between adjacent pixel points from being characterized of equal spacing between adjacent pixel points. For example, if the second displacement of a mesh point A is greater than the second displacement of a mesh point B, a change in the spacing between pixel points controlled by the mesh point A may be greater than a change in the spacing between pixel points controlled by the mesh point B.

For example, if the spacing between adjacent pixel points contained in a waist region is reduced, under the circumstance that the total number of pixel points corresponding to the waist remain the same, an effect of waist slimming is achieved. If the spacing between adjacent pixel points contained in a chest region is increased, under the circumstance that the total number of pixel points corresponding to the chest remain the same, an effect of chest enhancement is achieved.

Thus, the greater the change in the spacing between adjacent pixel points in the first area is, the greater the morphing amplitude of the corresponding part or region. Otherwise, the less the change in the spacing between adjacent pixel points in the first area is, the less the morphing amplitude of the corresponding part or region.

In the embodiment, by attenuating the displacement of a mesh point in the first region, the first displacement acquired based on the morphing instruction may be reduced to the second displacement. In this way, the morphing amplitude of the first region may be suppressed (i.e., weakened), thereby rendering the morphing amplitude of the first region different from the morphing amplitude of another region, meeting a requirement of different morphing amplitudes in different regions, thereby improving the effect in morphing the first image into the second image.

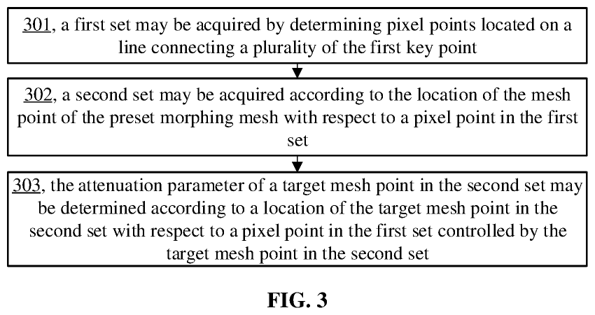

In some optional embodiments herein, as shown in FIG. 3, the attenuation parameter of the displacement of the mesh point may be determined according to the location of the mesh point of the preset morphing mesh in the first region with respect to the pixel point in the first region, as follows.

In S301, a first set may be acquired by determining pixel points located on a line connecting a plurality of the first key point.

In S302, a second set may be acquired according to the location of the mesh point of the preset morphing mesh with respect to a pixel point in the first set. The second set may include target mesh points of the morphing mesh each being closest to a pixel point in the first set.

In S303, the attenuation parameter of a target mesh point in the second set may be determined according to a location of the target mesh point in the second set with respect to a pixel point in the first set controlled by the target mesh point in the second set.

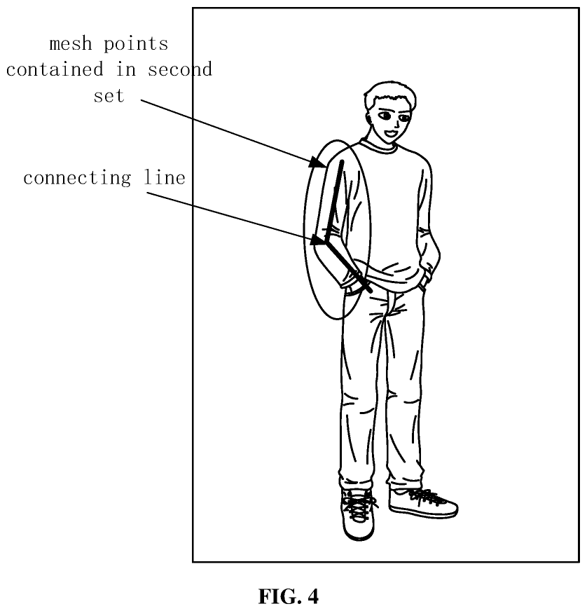

In the embodiment, after first key points have been determined, one or more connecting lines may be acquired by directly connecting adjacent first key points. Pixel points located on the line/lines may form a first set. As shown in FIG. 4, pixel points on a line connecting first key points may form a first set. After acquiring the first set, a mesh points each being respectively closest to a pixel point in the first set may be found according to the location of a mesh point in the morphing mesh with respect to the pixel point in the first set, and taken as target mesh points, forming a second set.

The first set may be formed by pixel points on the line connecting the first key points. The second set may include target mesh points adjacent to the connecting line. Therefore, the first set may be a set of pixel points, and the second set may be a set of mesh points, specifically of target mesh points.

During morphing, the first image may be morphed based on mesh points of the morphing mesh. A region enclosed by target mesh points in the second set may be the first region.

In the embodiment, a pixel point in the first set controlled by a target mesh point may be a pixel point closest to the target mesh point. Understandably, the attenuation parameter of a target mesh point in the second set may be determined according to locations of target mesh points with respect to pixel points on a line connecting the first key points.

Exemplarily, on one hand, some target mesh points in the second set may be close to the first key points, and some may be away from the first key points. A target mesh point in the second set close to a first key point may have a greater attenuation parameter compared to a target mesh point in the second set that is away from the first key point. On the other hand, pixel points in the first set may be part of pixel points in the first region. Of pixel points which are in the first region but beyond the first set, some may be close to pixel points in the first set, and some may be away from pixel points in the first set. A pixel point away from pixel points in the first set may generally controlled by a target mesh point away from the first key points. Therefore, the morphing amplitude of attenuating a pixel point away from the first key points may be less than the morphing amplitude of attenuating a pixel point close to the first key points.

In some optional embodiments herein, S303 may include a step as follows. A rank of spacing between the target mesh point in the second set and each of the first key point along a predetermined direction may be acquired by traversing the target mesh point in the second set outward along the predetermined direction starting from a center taken as the each of the first key point. The attenuation parameter of the target mesh point in the second set may be determined according to the rank of spacing.

In some embodiments, the attenuation parameter of a target mesh point in the second set may be determined according to a minimum distance between the target mesh point in the second set and each pixel point in the first set. The minimum distance may be an optional example of the spacing used in the rank of spacing. For example, assume that there are M pixel points in the first set, and N target mesh points in the second set. Both M and N may be positive integers. Each of the N target mesh points may have M distances from the M pixel points. The minimum distance of M distances corresponding to each of the N target mesh points may be determined. The rank of spacing may be acquired by sorting minimum distances corresponding to the N target mesh points. The less a minimum distance is, the closer ahead the minimum distance is in the rank of spacing, and the greater the attenuation parameter of the target mesh point corresponding to the minimum distance. Correspondingly, the greater a minimum distance is, the farther back the minimum distance is in the rank of spacing, and the less the attenuation parameter of the target mesh point corresponding to the minimum distance. In this way, the location of a mesh point with respect to the first key points may be represented by the spacing or the rank of spacing.

However, in this mode, in case the first part is in a specific posture, contrarily, the attenuation parameter of the mesh point closest to the center of the first part may be less, thereby lacking an expected image effect.

In the embodiment, a rank of spacing between each target mesh point in the second set and a first key point along a predetermined direction may be acquired by traversing the each target mesh point in the second set starting from the first key point. Exemplarily, the predetermined direction may be a direction along which morphing of the first part may have to be suppressed, or a direction along which morphing is prohibited. In some embodiments, the predetermined direction may be one of a widthwise line direction and a lengthwise line direction of the morphing mesh that forms a greater angle with the line connecting the corresponding first key points. In some other embodiments, the predetermined direction may be one of a widthwise line direction and a lengthwise line direction of the morphing mesh that forms a greater angle with the overall extension direction along which the line connecting the first key points extends. In still other embodiments, the predetermined direction may be one of a widthwise line direction and a lengthwise line direction of the morphing mesh that forms a greater angle with the extension direction along which the first part extends. In general, a mesh point in the second set may be located along the predetermined direction of but one pixel point.

In the embodiment, the rank of spacing may have a certain correlation with the corresponding attenuation parameter. For example, if an attenuation parameter is directly used for attenuating the first displacement of a target mesh point, then the closer ahead the rank of spacing is, the less the attenuation parameter.

In some optional embodiments, the attenuation parameter of the target mesh point in the second set may be determined according to the rank of spacing as follows. In case any one of the target mesh points in the second set is located along the predetermined direction with respect to the plurality of the first key point, alternative attenuation parameters may be determined according to the rank of spacing corresponding to the plurality of the first key point. A maximum alternative attenuation parameter of the alternative attenuation parameters may be selected as the attenuation parameter of the any one of the target mesh points.

In the implementation, if a target mesh point in the second set is located along the predetermined direction with respect to multiple first key points, multiple ranks of spacing will be determined. In this case, one rank of spacing may correspond to one attenuation parameter. Thus, ranks of spacing of a target mesh point corresponding to different first key points may be acquired, thereby acquiring multiple alternative attenuation parameters. In the end, the maximum alternative attenuation parameter of the alternative attenuation parameters may be selected as the attenuation parameter of the target mesh point, thereby ensuring that a target mesh point closer to the line connecting the first key points has a greater attenuation parameter.

In some optional embodiments herein, the first part may be an upper limb. The upper limb may include at least one of an upper arm, a forearm, and/or a hand.

In some optional embodiments herein, S110 may include a step as follows. Location information of a skeleton key point of the upper limb in the first image may be acquired. The skeleton key point may include at least one of a shoulder key point, an elbow key point, a wrist key point, and a hand key point. Then, the line connecting the first key points may be a line sequentially connecting at least one of a shoulder key point, an elbow key point, a wrist key point, till a hand key point. Then, pixel points contained in the first set may include at least one of: pixel points on the line connecting the shoulder key point and the elbow key point, pixel points on the line connecting the elbow key point and the wrist key point, pixel points on the line connecting the wrist key point and the hand key point.

In some optional embodiments herein, the method may further include a step as follows. A second region corresponding to the second part may be determined according to location information of a second key point of a second part contained in a target object in the first image. The morphed second image may be acquired by morphing the second region in the first image according to a first displacement of a mesh point of a preset morphing mesh in the second region. The first part may differ from the first part. Referring to FIG. 2B, the waist region other than the right upper limb may also be determined as the second region.

In the embodiments herein, first displacements of mesh points in both the first region and the second region may be an initial displacement determined according to a morphing instruction.

A morphing amplitude may be controlled by the displacement of a mesh point. Therefore, in the embodiment, the first region may be a region where morphing is to be suppressed, while the second region may be a region to be morphed. During morphing using a preset morphing mesh, the morphing amplitude of the first region may be made less than the morphing amplitude of the second region based on an attenuation parameter and the same morphing instruction. A morphing direction corresponding to a morphing amplitude may include, but is not limited to, at least one of increasing, decreasing, rotating, mirroring, changing the line shape, etc., of a morphing part of a corresponding region.

For example, when morphing a human in an image, if a first part to be morphed is the waist, when waist slimming morphing is performed using a preset morphing mesh by compressing the waist toward the center of the portrait, an arm located near the waist may be morphed and stretched.

To reduce impact of waist morphing on the arm, in the embodiment, the image region where the arm is located may be set as the first region, and the image region where the waist is located as the second region. In this way, in the embodiment, the first region and the second region may be morphed using the same morphing mesh through an attenuation parameter, rendering the morphing amplitude of the first region small and the morphing amplitude of the second region large. In this way, an effect of waist slimming is achieved through the large morphing of the second region, while the shape of the arm is maintained through the attenuation parameter of the first region, thereby improving the effect in morphing the entire image.

In some embodiments, the first region and the second region may be two adjacent regions.

In some embodiments, the first region and the second region may be two separate regions. For example, a third region may be provided between the first region and the second region. The second region may be a region containing the second part to be morphed. The first region may contain a region of the first part where morphing is to be suppressed. The third region may be a region that contains neither the first part nor the second part.

In some embodiments, a location mapping formula for morphing a mesh point outside the first region (such as in the second region) is as follows.

src+(dst−src) (1)

The src may be the location of the mesh point before morphing. The dst may be the location of the mesh point after morphing. The dst−src may be the first displacement.

A mesh point in the first region may be morphed using a formula (2) or a formula (3) for computing a second displacement.

src+(dst−src)*(1−s) (2)

The src may be the location of the mesh point before morphing. The dst may be the location of the mesh point after morphing. The dst-src may be the first displacement. The s may be an attenuation coefficient in an attenuation parameter. Exemplarily, the s may be any value between 0 and 1. The (Dst−src)*(1−s) may represent a second displacement less than the first displacement.

src+(dst−src)−S (3)

The src may be the location of the mesh point before morphing. The dst may be the location of the mesh point after morphing. The dst-src may be the first displacement. The S may be an attenuation value in the attenuation parameter. Exemplarily, the S may be any positive integer. The src+(dst−src)−S may represent a second displacement less than the first displacement.

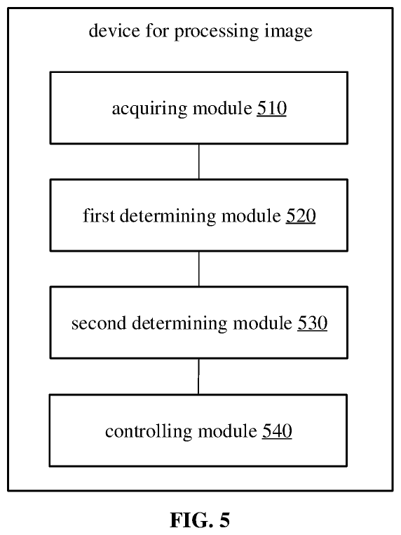

As shown in FIG. 5, embodiments herein further provide a device for processing an image, which includes an acquiring module 510, a first determining module 520, a second determining module 530, and a controlling module 540.

The acquiring module 510 is configured for acquiring location information of a first key point of a first part contained in a target object in a first image.

The first determining module 520 is configured for determining a first region containing the first key point based on the location information of the first key point.

The second determining module 530 is configured for determining, according to a location of a mesh point of a preset morphing mesh in the first region with respect to a pixel point in the first region, a displacement of the mesh point in the first region.

The controlling module 540 is configured for acquiring a morphed second image by morphing the pixel point in the first region according to the displacement of the mesh point in the first region.

A device for processing an image herein may be applied to various types of electronic equipment that may be used for image morphing, such as terminal equipment or a server.

In some embodiments, the acquiring module 510, the first determining module 520, the second determining module 530, and the controlling module 540 may all be program modules. Having been executed by a processor, the program modules may implement a function of any module herein.

In other embodiments, the acquiring module 510, the first determining module 520, the second determining module 530, and the controlling module 540 may all be modules combining software and hardware. The modules combining software and hardware may include various programmable arrays. A programmable array may include, but is not limited to, a complex programmable array or a field-programmable array.

In some other embodiments, the acquiring module 510, the first determining module 520, the second determining module 530, and the controlling module 540 may all be pure hardware modules. A pure hardware module may include, but is not limited to, an application specific integrated circuit.

In some embodiments, the second determining module 530 may be configured for: determining an attenuation parameter of the displacement of the mesh point according to the location of the mesh point of the preset morphing mesh in the first region with respect to the pixel point in the first region, and determining a first displacement of the mesh point according to a morphing instruction; and acquiring a second displacement less than the first displacement by attenuating the first displacement according to the attenuation parameter.

In some embodiments, the controlling module 540 may be configured for acquiring the morphed second image by controlling a spacing between adjacent pixel points in the first region according to the second displacement.

In some embodiments, the second determining module 530 may be configured for: acquiring a first set by determining pixel points located on a line connecting a plurality of the first key point; acquiring a second set according to the location of the mesh point of the preset morphing mesh with respect to a pixel point in the first set, the second set including target mesh points of the morphing mesh each being closest to a pixel point in the first set; and determining the attenuation parameter of a target mesh point in the second set according to a location of the target mesh point in the second set with respect to a pixel point in the first set controlled by the target mesh point in the second set.

In some embodiments, the second determining module 530 may be configured for: acquiring a rank of spacing between the target mesh point in the second set and each of the first key point along a predetermined direction by traversing the target mesh point in the second set outward along the predetermined direction starting from a center taken as the each of the first key point; and determining the attenuation parameter of the target mesh point in the second set according to the rank of spacing.

In some embodiments, the second determining module 530 may be configured for: in response to any one of the target mesh points in the second set being located along the predetermined direction with respect to the plurality of the first key point, determining alternative attenuation parameters according to the rank of spacing corresponding to the plurality of the first key point; and selecting a maximum alternative attenuation parameter of the alternative attenuation parameters as the attenuation parameter of the any one of the target mesh points.

In some embodiments, the first part may be an upper limb. The acquiring module 510 may be configured for acquiring location information of a skeleton key point of the upper limb in the first image. The skeleton key point may include at least one of a shoulder key point, an elbow key point, a wrist key point, and a hand key point.

In some embodiments, the first determining module 520 may be further configured for determining, according to location information of a second key point of a second part contained in a target object in the first image, a second region corresponding to the second part.

The controlling module 540 may be further configured for acquiring the morphed second image by morphing the second region in the first image according to a first displacement of a mesh point of a preset morphing mesh in the second region.

The embodiment is elaborated exemplarily below.

Mesh morphing may be a morphing tool used for image morphing. The morphing mesh before morphing may be a regular mesh, usually including straight longitude and latitude lines forming a rectangular mesh.

A first region and a second region may be determined on an image to be morphed. The first region may be a region including a first part the morphing amplitude of which is to be suppressed, while compared to the first region, the second region may be a region including a second part the morphing amplitude of which is not to be suppressed. For example, when the morphing mesh is used to morph the waist of a human, an arm may be beside the waist. A technical solution herein may be adopted to reduce impact of the waist morphing on the arm. The arm may be the first part, and the waist may be the second part.

In the example, a second displacement less than the first displacement may be acquired by performing attenuation processing based on the first displacement of a mesh point falling within the first region. For example, the first displacement may be an original displacement directly acquired based on a morphing instruction.

In this way, by reducing the displacement of a mesh point in the first region, the morphing amplitude of a pixel point in the first region may be reduced.

Exemplarily, taking the arm as the first part, and taking an image region containing the arm as the first region, the image processing method provided in the example may include steps as follows.

First, a first key point may be determined, such as by determining four key points of the arm as the first key points. Assume that the four the first key points are referred to as key points A, B, C, and D. For example, for an upper limb, the four key points A, B, C, and D may be a shoulder key point, an elbow key point, a wrist key point, and a hand key point.

Secondly, the four key points A, B, C, and D may be connected, acquiring a line connecting the first key points.

Thirdly, a first set and a second set may be determined. Pixel points included in the first set may be located on the connecting line. The mesh points contained in the second set may be mesh points in the morphing mesh each being closest to a pixel point in the first set.

Fourthly, an attenuation parameter of each target mesh point in the second set may be determined according to the location of the each target mesh point in the second set with respect to a pixel point in the first set controlled by the each mesh point.

Fifthly, for the first region, the first displacement may be attenuated according to the attenuation parameter of each mesh point, acquiring a second displacement less than the first displacement. Morphing may be performed based on the second displacement. For the second region, morphing may be performed based directly on the first displacement.

Therefore, by precisely controlling the displacement of a mesh point in the first region, the morphing amplitude of the first region may be made less than the morphing amplitude of the second region, implementing fine control of morphing of pixel points in different regions in the same image, thereby improving an image morphing effect.

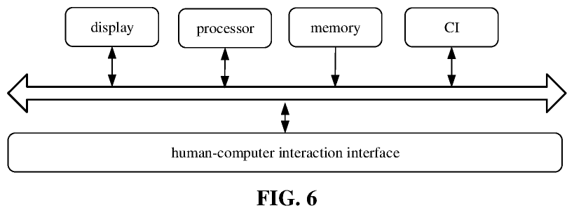

As shown in FIG. 6, embodiments herein further provide a device for processing an image, which may include memory and a processor.

The memory is configured for store information.

The processor is connected to a display and the memory respectively. The processor is configured for implementing, by executing computer-executable instructions stored in the memory, a method for processing an image provided in one or more abovementioned technical solutions, such as the method for processing an image as shown in FIG. 1 and/or FIG. 3.

The memory may be various types of memory, such as Random Access Memory (RAM), Read-Only Memory (ROM), flash memory, etc. The memory may be used for storing information, such as computer-executable instructions. The computer-executable instructions may be various program instructions, such as target program instructions and/or source program instructions.

The processor may be various types of processors, such as a central processing unit, a microprocessor, a digital signal processor, a programmable array, a digital signal processor, an application specific integrated circuit, an image processor, etc.

The processor may be connected to the memory through a bus. The bus may be an integrated circuit bus, etc.

In some embodiments, the terminal equipment may further include a communication interface (CI). The communication interface may include a network interface, such as a local area network interface, a transceiver antenna, etc. The communication interface may also be connected to the processor and may be configured for transmitting and receiving information.

In some embodiments, the terminal equipment may further include a human-computer interaction interface. For example, the human-computer interaction interface may include various input/output equipment such as a keyboard, a touch screen, etc.

In some embodiments, the device for processing an image may further include a display. The display may display various prompts, collected face images and/or various interfaces.

Embodiments herein provide a computer storage medium having stored thereon a computer executable code which, when executed, may implement a method for processing an image provided in one or more abovementioned technical solutions, such as the method for processing an image as shown in FIG. 1 and/or FIG. 3.

Note that in embodiments herein, the disclosed equipment and method may be implemented in other ways. The described equipment embodiments are merely exemplary. For example, the unit division is merely logical function division and may be other division in actual implementation. For example, multiple units or components may be combined, or integrated into another system, or some features/characteristics may be omitted or skipped. Furthermore, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separate. Components shown as units may be or may not be physical units; they may be located in one place, or distributed on multiple network units. Some or all of the units may be selected to achieve the purpose of a solution of the embodiments as needed.

In addition, various functional units in each embodiment herein may be integrated in one processing module, or exist as separate units respectively; or two or more such units may be integrated in one unit. The integrated unit may be implemented in form of hardware, or hardware plus software functional unit(s).

Technical features disclosed in any embodiment herein may be combined arbitrarily to form a new method embodiment or a new device embodiment as long as no conflict results from the combination.

Method embodiments disclosed in any embodiment herein may be combined arbitrarily to form a new method embodiment as long as no conflict results from the combination.

Device embodiments disclosed in any embodiment herein may be combined arbitrarily to form a new device embodiment as long as no conflict results from the combination.

A skilled person in the art may understand that all or part of the steps of the embodiments may be implemented by instructing a related hardware through a program, which program may be stored in a computer-readable storage medium and when executed, execute steps including those of the embodiments. The computer-readable storage medium may be various media that may store program codes, such as mobile storage equipment, Read-Only Memory (ROM), a magnetic disk, a CD, etc.

What described are but embodiments herein and are not intended to limit the scope herein. Any modification, equivalent replacement, and/or the like made within the technical scope herein, as may occur to a person having ordinary skill in the art, shall be included in the scope herein. The scope herein thus should be determined by the claims.

What is claimed is:

1. A method for processing an image, comprising:
acquiring location information of a first key point of a first part contained in a target object in a first image;
determining a first region containing the first key point based on the location information of the first key point;
determining, according to a location of a mesh point of a preset morphing mesh in the first region with respect to a pixel point in the first region, a displacement of the mesh point in the first region; and
acquiring a morphed second image by morphing the pixel point in the first region according to the displacement of the mesh point in the first region.

2. The method of claim 1, wherein determining, according to the location of the mesh point of the preset morphing mesh in the first region with respect to the pixel point in the first region, the displacement of the mesh point in the first region comprises:
determining an attenuation parameter of the displacement of the mesh point according to the location of the mesh point of the preset morphing mesh in the first region with respect to the pixel point in the first region, and determining a first displacement of the mesh point according to a morphing instruction; and
acquiring a second displacement less than the first displacement by attenuating the first displacement according to the attenuation parameter.

3. The method of claim 2, wherein acquiring the morphed second image by morphing the pixel point in the first region according to the displacement of the mesh point in the first region comprises:
acquiring the morphed second image by controlling a spacing between adjacent pixel points in the first region according to the second displacement.

4. The method of claim 2, wherein determining the attenuation parameter of the displacement of the mesh point according to the location of the mesh point of the preset morphing mesh in the first region with respect to the pixel point in the first region comprises:
acquiring a first set by determining pixel points located on a line connecting a plurality of the first key point;
acquiring a second set according to the location of the mesh point of the preset morphing mesh with respect to a pixel point in the first set, the second set comprising target mesh points of the morphing mesh each being closest to a pixel point in the first set; and
determining the attenuation parameter of a target mesh point in the second set according to a location of the target mesh point in the second set with respect to a pixel point in the first set controlled by the target mesh point in the second set.

5. The method of claim 4, wherein determining the attenuation parameter of the target mesh point in the second set according to the location of the target mesh point in the second set with respect to the pixel point in the first set controlled by the target mesh point in the second set comprises:
acquiring a rank of spacing between the target mesh point in the second set and each of the first key point along a predetermined direction by traversing the target mesh point in the second set outward along the predetermined direction starting from a center taken as the each of the first key point; and
determining the attenuation parameter of the target mesh point in the second set according to the rank of spacing.

6. The method of claim 5, wherein determining the attenuation parameter of the target mesh point in the second set according to the rank of spacing comprises:
in response to any one of the target mesh points in the second set being located along the predetermined direction with respect to the plurality of the first key point, determining alternative attenuation parameters according to the rank of spacing corresponding to the plurality of the first key point; and
selecting a maximum alternative attenuation parameter of the alternative attenuation parameters as the attenuation parameter of the any one of the target mesh points.

7. The method of claim 1, wherein the first part is an upper limb, wherein acquiring the location information of the first key point of the first part contained in the target object in the first image comprises:
acquiring location information of a skeleton key point of the upper limb in the first image, the skeleton key point comprising at least one of a shoulder key point, an elbow key point, a wrist key point, and a hand key point.

8. The method of claim 1, further comprising:
determining, according to location information of a second key point of a second part contained in a target object in the first image, a second region corresponding to the second part; and
acquiring the morphed second image by morphing the second region in the first image according to a first displacement of a mesh point of a preset morphing mesh in the second region.

9. The method of claim 2, wherein the first part is an upper limb, wherein acquiring the location information of the first key point of the first part contained in the target object in the first image comprises:
acquiring location information of a skeleton key point of the upper limb in the first image, the skeleton key point comprising at least one of a shoulder key point, an elbow key point, a wrist key point, and a hand key point.

10. The method of claim 2, further comprising:
determining, according to location information of a second key point of a second part contained in a target object in the first image, a second region corresponding to the second part; and
acquiring the morphed second image by morphing the second region in the first image according to a first displacement of a mesh point of a preset morphing mesh in the second region.

11. The method of claim 3, wherein the first part is an upper limb, wherein acquiring the location information of the first key point of the first part contained in the target object in the first image comprises:
acquiring location information of a skeleton key point of the upper limb in the first image, the skeleton key point comprising at least one of a shoulder key point, an elbow key point, a wrist key point, and a hand key point.

12. A device for processing an image, comprising memory and a processor connected to the memory,
wherein the processor is configured, by executing computer-executable instructions stored on the memory, for:
acquiring location information of a first key point of a first part contained in a target object in a first image;
determining a first region containing the first key point based on the location information of the first key point;
determining, according to a location of a mesh point of a preset morphing mesh in the first region with respect to a pixel point in the first region, a displacement of the mesh point in the first region; and
acquiring a morphed second image by morphing the pixel point in the first region according to the displacement of the mesh point in the first region.

13. The device of claim 12, wherein the processor is configured for determining, according to the location of the mesh point of the preset morphing mesh in the first region with respect to the pixel point in the first region, the displacement of the mesh point in the first region, by:
determining an attenuation parameter of the displacement of the mesh point according to the location of the mesh point of the preset morphing mesh in the first region with respect to the pixel point in the first region, and determining a first displacement of the mesh point according to a morphing instruction; and
acquiring a second displacement less than the first displacement by attenuating the first displacement according to the attenuation parameter.

14. The device of claim 13, wherein the processor is configured for acquiring the morphed second image by morphing the pixel point in the first region according to the displacement of the mesh point in the first region, by:
acquiring the morphed second image by controlling a spacing between adjacent pixel points in the first region according to the second displacement.

15. The device of claim 13, wherein the processor is configured for determining the attenuation parameter of the displacement of the mesh point according to the location of the mesh point of the preset morphing mesh in the first region with respect to the pixel point in the first region, by:
acquiring a first set by determining pixel points located on a line connecting a plurality of the first key point;
acquiring a second set according to the location of the mesh point of the preset morphing mesh with respect to a pixel point in the first set, the second set comprising target mesh points of the morphing mesh each being closest to a pixel point in the first set; and
determining the attenuation parameter of a target mesh point in the second set according to a location of the target mesh point in the second set with respect to a pixel point in the first set controlled by the target mesh point in the second set.

16. The device of claim 15, wherein the processor is configured for determining the attenuation parameter of the target mesh point in the second set according to the location of the target mesh point in the second set with respect to the pixel point in the first set controlled by the target mesh point in the second set, by:
acquiring a rank of spacing between the target mesh point in the second set and each of the first key point along a predetermined direction by traversing the target mesh point in the second set outward along the predetermined direction starting from a center taken as the each of the first key point; and
determining the attenuation parameter of the target mesh point in the second set according to the rank of spacing.

17. The device of claim 16, wherein the processor is configured for determining the attenuation parameter of the target mesh point in the second set according to the rank of spacing, by:
in response to any one of the target mesh points in the second set being located along the predetermined direction with respect to the plurality of the first key point, determining alternative attenuation parameters according to the rank of spacing corresponding to the plurality of the first key point; and
selecting a maximum alternative attenuation parameter of the alternative attenuation parameters as the attenuation parameter of the any one of the target mesh points.

18. The device of claim 12, wherein the first part is an upper limb, wherein the processor is configured for acquiring the location information of the first key point of the first part contained in the target object in the first image by:
acquiring location information of a skeleton key point of the upper limb in the first image, the skeleton key point comprising at least one of a shoulder key point, an elbow key point, a wrist key point, and a hand key point.

19. The device of claim 12, wherein the processor is configured for:
determining, according to location information of a second key point of a second part contained in a target object in the first image, a second region corresponding to the second part; and
acquiring the morphed second image by morphing the second region in the first image according to a first displacement of a mesh point of a preset morphing mesh in the second region.

20. A non-transitory computer storage medium, having stored thereon computer-executable instructions which, when executed by a processor, implement:
acquiring location information of a first key point of a first part contained in a target object in a first image;
determining a first region containing the first key point based on the location information of the first key point;
determining, according to a location of a mesh point of a preset morphing mesh in the first region with respect to a pixel point in the first region, a displacement of the mesh point in the first region; and
acquiring a morphed second image by morphing the pixel point in the first region according to the displacement of the mesh point in the first region.
